(19) United States
(12) Patent Application Publication
(10) Pub. No.: US 2026/0002551 A1
(43) Pub. Date: Jan. 1, 2026

(54) FLUID SYSTEM DAMPING ADJUSTING VALVES

(71) Applicant: Hamilton Sundstrand Corporation, Charlotte, NC (US)

(72) Inventors: Todd Haugsjaahabink, Amherst, MA (US); Juan Du, Simsbury, CT (US); August Coretto, Windsor, CT (US); Michael Ferrarotti, Durham, CT (US); Steve Doerner, Enfield, CT (US)

(21) Appl. No.: 19/253,570

(22) Filed: Jun. 27, 2025

Related U.S. Application Data
(60) Provisional application No. 63/665,718, filed on Jun. 28, 2024.

(51) Int. Cl. F15B 13/04

(52) U.S. Cl. CPC F15B 13/0407

(57) ABSTRACT

A fluid system includes a reference pressure source, a first valve, and a second valve. The first valve includes a housing with a first damping port fluidically connected to the reference pressure source and a second damping port fluidically connected to the reference pressure source. The first valve also includes a spool moveable within the housing. The spool includes a damping window formed on the spool. The damping window fluidically connects the first damping port to the second damping port. The second valve is fluidically connected to at least one of the first damping port and the second damping port.

### CROSS-REFERENCE TO RELATED APPLICATION(S)

The present application claims priority to U.S. Provisional Patent Application No. 63/665,718 filed on Jun. 28, 2024, the contents of which are incorporated by reference herein in their entirety.

### BACKGROUND

Typically, fuel control valves use a damping orifice to maintain stability. This orifice must be small enough to provide stability to the fuel control valve, but not so small that the orifice slows down the fuel control valve too much to meet bandwidth response needs. On some turbine engine fuel systems, operating conditions, such as pressures and flow rates, can have very wide ranges. This poses a problem when designing valves which must maintain both stability and response capability over all conditions.

### SUMMARY

In one example of the disclosure, a fuel system includes a reference pressure source, a first valve, and a second valve. The first valve includes a housing with an inlet and an outlet fluidically connected to the inlet. The housing of the first valve also includes a first damping port fluidically connected to the reference pressure source, and a second damping port fluidically connected to the reference pressure source. The first valve also includes a spool moveable within the housing to fluidically open and close the inlet relative to the outlet. The spool includes a damping window formed on the spool. The damping window fluidically connects the first damping port to the second damping port. The second valve is fluidically connected to at least one of the first damping port and the second damping port.

In another example of the disclosures, a fluid system includes a reference pressure source, a first valve, and a second valve. The first valve includes a housing and a spool. The housing includes a first damping port fluidically connected to the reference pressure source and a second damping port fluidically connected to the reference pressure source. The spool is moveable within the housing and includes a damping window formed on the spool. The damping window fluidically connects the first damping port to the second damping port. The second valve is fluidically connected to at least one of the first damping port and the second damping port.

### BRIEF DESCRIPTION OF THE DRAWINGS

FIG. 1 is a schematic diagram of one example of a fuel system with a valve comprising a damping window.

FIG. 2 is a schematic diagram of another example of the fuel system with the valve comprising the damping window.

FIG. 3 is a schematic diagram of another example of the fuel system with the valve comprising the damping window.

### DETAILED DESCRIPTION

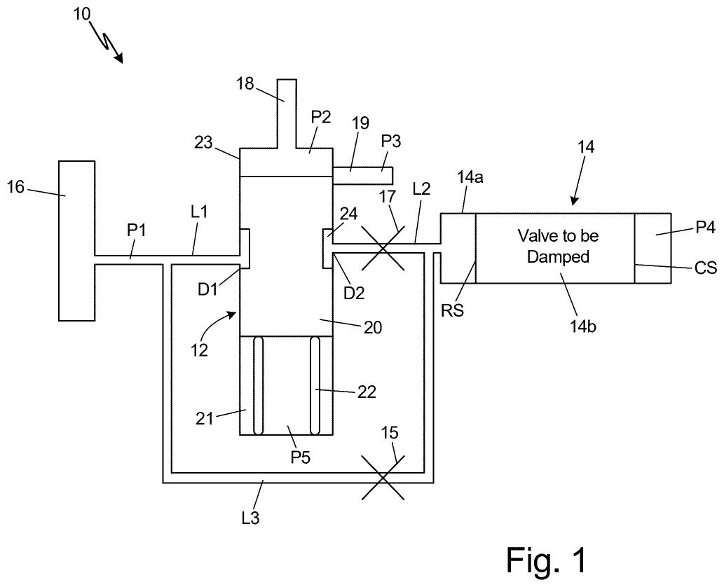

The following disclosure includes a fuel system with a first valve and a second valve. The first valve includes a damping window that fluidically connects a reference side of a spool in the second valve to a reference pressure source. The damping window functions as a variable orifice incorporated into the first valve that can be adjusted by the first valve to vary a response time of the second valve. The fuel system is discussed in greater detail below with reference to FIGS. 1-3.

As shown in the example of FIG. 1, fuel system 10 includes first valve 12, second valve 14, fixed orifice 15, reference pressure source 16, fixed orifice 17, and lines L1-L3. First valve 12 includes inlet 18, outlet 19, spool 20, control chamber 21, spring 22, housing 23, first damping port D1, second damping port D2, and damping window 24. Second valve 14 includes housing 14a and spool 14b with reference side RS and control side CS.

In the example of FIG. 1, inlet 18 is formed in housing 23 of first valve 12, is on a first side of spool 20 and is fluidically connected to outlet 19 when not obstructed by spool 20. Control chamber 21 is on a second side of spool 20 opposite from the first side of spool 20 and inlet 18. Spring 22 is inside control chamber 21 and biases spool 20 toward inlet 18. Damping window 24 is formed on spool 20 between the first side and the second side of spool 20. The first side of spool 20 can also be referred to as the first end of spool 20, and the second side of spool 20 can also be referred to as the second end of spool 20. First damping port D1 is formed in housing 23 of first valve 12 and is fluidically connected to damping window 24. Second damping port D2 is formed in housing 23 of first valve 12 and is fluidically connected to damping window 24.

Spool 14b of second valve 14 is inside housing 14a of second valve 14 and is between a first end and a second end of housing 14a. Reference surface RS of spool 14b of second valve 14 faces the first end of housing 14a of second valve 14. Control surface CS of spool 14b of second valve 14 faces a second end of housing 14a of second valve 14.

Line L1 fluidically connects first damping port D1 and damping window 24 to reference pressure source 16. Line L2 fluidically connects second damping port D2 and damping window 24 to reference surface RS of second valve 14. Line L3 fluidically connects line L1 and line L2 together. As shown in the example of FIG. 1, reference pressure source 16, line L1, line L2, line L3 and damping window 24 are all at a first pressure P1 that is provided by reference pressure source 16. Fixed orifice 15 can be included in line L3 and fixed orifice 17 can be included in line L2. Fixed orifices 15 and 17 are optional. Line L3 can connect to line L2 between second valve 14 and fixed orifice 17.

During operation of fuel system 10, spool 20 of first valve 12 can move within housing 23 to adjust flow of a fluid (such as fuel) from inlet 18 at pressure P2 to outlet 19 at pressure P3. The pressure P5 within control chamber 21 can be adjusted by a controller (not shown) to control the movement and placement of spool 20 within housing 23. Also during operation of fuel system 10, spool 14b of second valve 14 can move within housing 14a of second valve 14 based on a pressure P4 acting on control surface CS of spool 14b. Second valve 14 can be a control valve that includes a plurality of inlet and outlet ports (not shown) to control flow in fuel system 10 based upon a position of spool 14b within housing 14a of second valve 14.

During operation of second valve 14a, damping window 24, first damping port D1, and second damping port D2 of first valve 12 will function as an adjustable damping orifice for second valve 14 with a restriction that is dependent on a stroke and position of spool 20 in first valve 12. When second valve 14 requires a fast response time, spool 20 in first valve 12 can be positioned within housing 23 such that first damping port D1 and second damping port D2 are wide open to damping window 24, allowing spool 14b of second valve 14 to respond quickly to the pressure P4 acting on control surface CS. When the response time of second valve 14 needs to be slower, the pressure P5 in control chamber 21 of first valve 12 can be adjusted such that spool 20 partially obstructs first damping port D1 and second damping port D2, thereby restricting flow between line L1 and line L2 via damping window 24 when spool 14b of second valve 14 moves inside of second valve 14 in response to the pressure P4 acting on control surface CS. Fixed orifices 15 and 17 can also be included in line L3 and line L2 respectively to provide additional damping for second valve 14 but are optional.

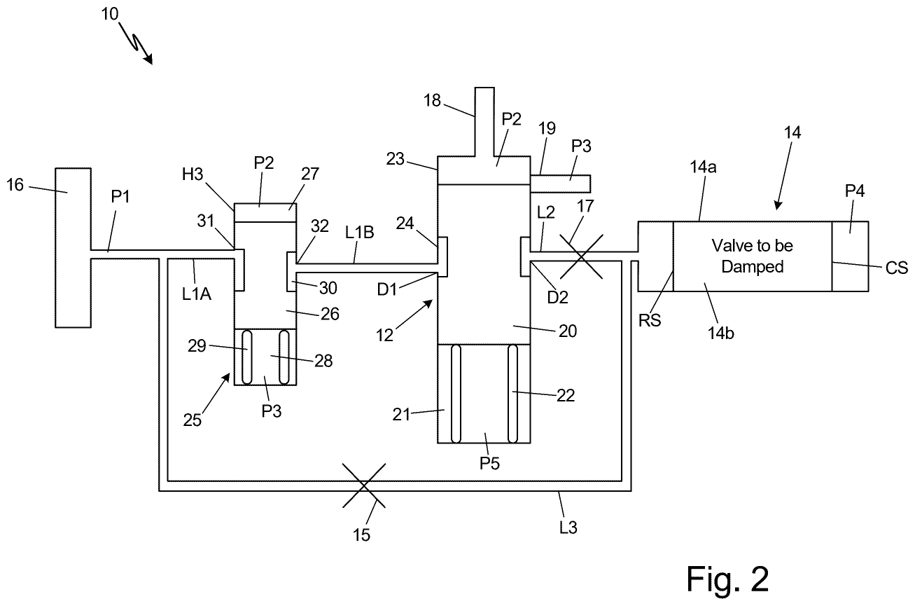

FIG. 2 is another example of fuel system 10 that further includes damping regulator valve 25. Damping regulator valve 25 includes spool 26, first control chamber 27, second control chamber 28, housing H3, and spring 29. Spool 26 of damping regulator valve 25 includes window 30. Housing H3 includes first port 31 and second port 32.

Damping regulator valve 25 is positioned in line L1 from the example of fuel system 10 of FIG. 1 and is in flow series with damping window 24 of first valve 12. Line L1 includes sub-line L1A that fluidically connects window 30 of damping regulator valve 25 to reference pressure source 16. Line L1 also includes sub-line L1B that fluidically connects window 30 of damping regulator valve 25 to first damping port D1 and damping window 24 of first valve 12. Housing H3 of damping regulator valve 25 extends between a first end and a second end of damping regulator valve 25. First port 31 is formed in housing H3 and is fluidically connected to reference pressure source 16. Second port 31 is formed in housing H3 and is fluidically connected to first damping port D1 of first valve 12. Spool 26 of damping regulator valve 25 is in housing H3, and window 30 is formed in spool 26 between a first side and a second side of spool 26. Window 30 is fluidically connected to first port 31 and second port 32. Window 30 of damping regulator valve 25 can be positioned in flow series with damping window 24 of first valve 12. Similar to damping window 24 of first valve 12, window 30 is also at the first pressure P1.

First control chamber 27 is on a first side of spool 26 and second control chamber 28 is on a second side of spool 26. As shown in the example of FIG. 1, first control chamber 27 is fluidically connected to inlet 18 of first valve 12 such that first control chamber 27 receives a pressure signal from inlet 18 that is at a second pressure P2, the second pressure P2 being the pressure at inlet 18. Second control chamber 28 is fluidically connected to outlet 19 of first valve 12 such that second control chamber 28 receives a pressure signal from outlet 19 that is at a third pressure P3, the third pressure P3 being the pressure at outlet 19.

During operation of the example of fuel system 10 shown in FIG. 2, damping window 24, first damping port D1, and second damping port D2 of first valve 12 will function as an adjustable damping orifice for second valve 14 that is dependent on a stroke and position of spool 20 in first valve 12. Furthermore, window 30 of damping regulator valve 25 will function as an adjustable damping orifice for second valve 14 with a restriction that is dependent on a delta pressure (i.e., pressure difference) between the second pressure P2 of inlet 18 of first valve 12 and the third pressure P3 of outlet 19 of first valve 12.

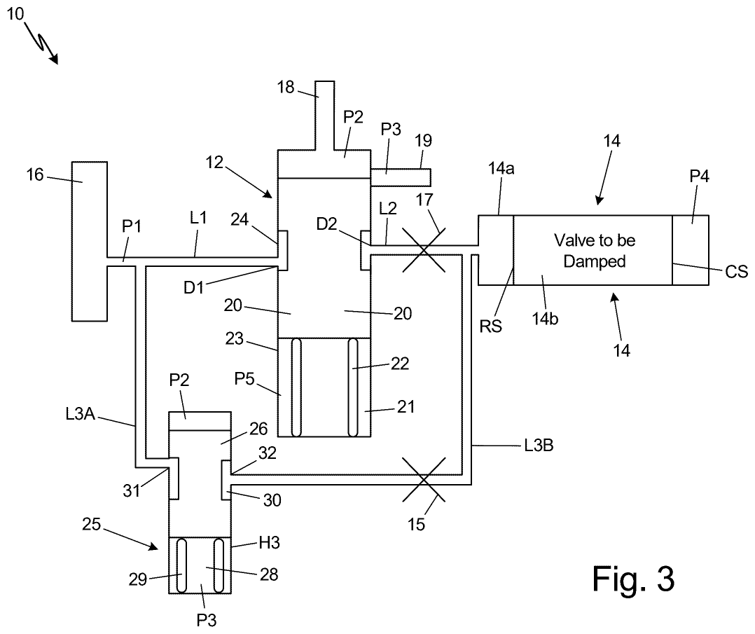

FIG. 3 is a schematic diagram of another example of fuel system 10. The example of fuel system 10 shown in FIG. 3 is similar to the example of FIG. 2, except that damping regulator valve 25 is positioned in line L3 from the example of fuel system 10 of FIG. 1 and is in flow parallel with damping window 24 of first valve 12.

### Discussion of Possible Embodiments

The following are non-exclusive descriptions of possible examples of the present invention.

In one example of the disclosure, a fuel system includes a reference pressure source, a first valve, and a second valve. The first valve includes a housing with an inlet and an outlet fluidically connected to the inlet. The housing of the first valve also includes a first damping port fluidically connected to the reference pressure source, and a second damping port fluidically connected to the reference pressure source. The first valve also includes a spool moveable within the housing to fluidically open and close the inlet relative to the outlet. The spool includes a damping window formed on the spool. The damping window fluidically connects the first damping port to the second damping port. The second valve is fluidically connected to at least one of the first damping port and the second damping port.

The fuel system of the preceding paragraph can optionally include, additionally and/or alternatively, any one or more of the following features, configurations and/or additional components in the paragraphs below.

In an embodiment of the foregoing fuel system, the second valve comprises: a housing comprising a first end and a second end; and a spool within the housing and between the first and second end, wherein the spool of the second valve comprises: a reference surface facing the first end of the housing of the second valve; and a control surface facing a second end of the housing of the second valve.

In an embodiment of the foregoing fuel system, the fuel system further comprises: a first line fluidically connecting the first damping port to the reference pressure source; and a second line fluidically connecting the second damping port to the reference side of the spool of the second valve.

In an embodiment of the foregoing fuel system, the fuel system further comprises a third line fluidically connecting the first line to the second line.

In an embodiment of the foregoing fuel system, the fuel system further comprises: a first orifice in the third line; and a second orifice in the second line and fluidically between the second damping port and a connection between the second line and the third line.

In an embodiment of the foregoing fuel system, the first valve further comprises: a control chamber between the housing of the first valve and the spool of the first valve, wherein the spool is between the control chamber and the inlet of the first valve; and a spring in the control chamber.

In an embodiment of the foregoing fuel system, the fuel system further comprises: a third valve in the first line fluidically between the reference pressure source and the first damping port of the first valve, wherein the third valve comprises: a third housing extending between a first end and a second end of the third valve, the third housing comprising: a first port; and a second port; a third spool in the third housing, wherein the third spool comprises: a first side opposite a second side; and a window between the first side and the second side of the third spool, wherein the window of the third spool is fluidically connected to the first port and the second port; a first control chamber between first side of the third spool and the first end of the third valve, wherein the first control chamber is fluidically connected to the inlet of the first valve to sense a pressure of the inlet of the first valve; a second control chamber between a second side of the third spool and the second end of the third valve, wherein the second control chamber is fluidically connected to the outlet of the first valve to sense a pressure of the outlet of the first valve; and a spring in the second control chamber.

In an embodiment of the foregoing fuel system, the first line further comprises: a first sub-line fluidically connecting the first port of the third valve to the reference pressure source; and a second sub-line fluidically connecting the second port of the third valve to the first damping port of the first valve.

In an embodiment of the foregoing fuel system, the fuel system further comprises: a third valve in the third line, wherein the third valve comprises: a third housing extending between a first end and a second end of the third valve, the third housing comprising: a first port; and a second port; a third spool in the third housing, wherein the third spool comprises: a first side opposite a second side; and a window between the first side and the second side of the third spool, wherein the window of the third spool is fluidically connected to the first port and the second port; a first control chamber between first side of the third spool and the first end of the third valve, wherein the first control chamber is fluidically connected to the inlet of the first valve to sense a pressure of the inlet of the first valve; a second control chamber between a second side of the third spool and the second end of the third valve, wherein the second control chamber is fluidically connected to the outlet of the first valve to sense a pressure of the outlet of the first valve; and a spring in the second control chamber.

In an embodiment of the foregoing fuel system, the third line further comprises: a first sub-line fluidically connecting the first port of the third valve to the first line; and a second sub-line fluidically connecting the second port of the third valve to the second line.

In an embodiment of the foregoing fuel system, the fuel system further comprises: a first orifice in the third line and fluidically between third valve and the second line; and a second orifice in the second line and fluidically between the second damping port of the first valve and a connection between the second line and the third line.

In another example of the disclosures, a fluid system includes a reference pressure source, a first valve, and a second valve. The first valve includes a housing and a spool. The housing includes a first damping port fluidically connected to the reference pressure source and a second damping port fluidically connected to the reference pressure source. The spool is moveable within the housing and includes a damping window formed on the spool. The damping window fluidically connects the first damping port to the second damping port. The second valve is fluidically connected to at least one of the first damping port and the second damping port.

The fuel system of the preceding paragraph can optionally include, additionally and/or alternatively, any one or more of the following features, configurations and/or additional components in the paragraphs below.

In an embodiment of the foregoing fuel system, the first valve further comprises: an inlet; and an outlet fluidically connected to the inlet, wherein the spool is moveable within the housing to fluidically open and close the inlet relative to the outlet.

In an embodiment of the foregoing fuel system, the second valve comprises: a housing comprising a first end and a second end; and a spool within the housing and between the first and second end, wherein the spool of the second valve comprises: a reference surface facing the first end of the housing of the second valve; and a control surface facing a second end of the housing of the second valve.

In an embodiment of the foregoing fuel system, the fuel system further comprises: a first line fluidically connecting the first damping port to the reference pressure source; and a second line fluidically connecting the second damping port to the reference side of the spool of the second valve.

In an embodiment of the foregoing fuel system, the fuel system further comprises a third line fluidically connecting the first line to the second line.

In an embodiment of the foregoing fuel system, the fuel system further comprises: a third valve in the third line, wherein the third valve comprises: a third housing extending between a first end and a second end of the third valve, the third housing comprising: a first port fluidically connected to the reference pressure source and the first damping port; and a second port fluidically connected to the damping window by the second damping port; a third spool in the third housing, wherein the third spool comprises: a first side opposite a second side; and a window between the first side and the second side of the third spool, wherein the window of the third spool is fluidically connected to the first port and the second port; a first control chamber between first side of the third spool and the first end of the third valve, wherein the first control chamber is fluidically connected to the inlet of the first valve to sense a pressure of the inlet of the first valve; a second control chamber between a second side of the third spool and the second end of the third valve, wherein the second control chamber is fluidically connected to the outlet of the first valve to sense a pressure of the outlet of the first valve; and a spring in the second control chamber.

In an embodiment of the foregoing fuel system, the fuel system further comprises: a first orifice in the third and fluidically between third valve and the second line; and a second orifice in the second line and fluidically between the second damping port of the first valve and a connection between the second line and the third line.

In an embodiment of the foregoing fuel system, the fuel system further comprises: a third valve in the first line fluidically between the reference pressure source and the first damping port of the first valve, wherein the third valve comprises: a third housing extending between a first end and a second end of the third valve, the third housing comprising: a first port; and a second port; a third spool in the third housing, wherein the third spool comprises: a first side opposite a second side; and a window between the first side and the second side of the third spool, wherein the window of the third spool is fluidically connected to the first port and the second port; a first control chamber between first side of the third spool and the first end of the third valve, wherein the first control chamber is fluidically connected to the inlet of the first valve to sense a pressure of the inlet of the first valve; a second control chamber between a second side of the third spool and the second end of the third valve, wherein the second control chamber is fluidically connected to the outlet of the first valve to sense a pressure of the outlet of the first valve; and a spring in the second control chamber.

In an embodiment of the foregoing fuel system, the fuel system further comprises: a first orifice in the third; and a second orifice in the second line and fluidically between the second damping port of the first valve and a connection between the second line and the third line.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

The status of the claims is as follows:

1. A fuel system comprising:
a reference pressure source;
a first valve comprising:
a housing comprising:
an inlet;
an outlet fluidically connected to the inlet;
a first damping port fluidically connected to the reference pressure source; and
a second damping port fluidically connected to the reference pressure source;
a spool moveable within the housing to fluidically open and close the inlet relative to the outlet, wherein the spool comprises:
a damping window formed on the spool, wherein the damping window fluidically connects the first damping port to the second damping port; and
a second valve fluidically connected to at least one of the first damping port and the second damping port.

2. The fuel system of claim 1, wherein the second valve comprises:
a housing comprising a first end and a second end; and
a spool within the housing and between the first and second end, wherein the spool of the second valve comprises:
a reference surface facing the first end of the housing of the second valve; and
a control surface facing a second end of the housing of the second valve.

3. The fuel system of claim 2, further comprising:
a first line fluidically connecting the first damping port to the reference pressure source; and
a second line fluidically connecting the second damping port to the reference side of the spool of the second valve.

4. The fuel system of claim 3, further comprising:
a third line fluidically connecting the first line to the second line.

5. The fuel system of claim 4, further comprising:
a first orifice in the third line; and
a second orifice in the second line and fluidically between the second damping port and a connection between the second line and the third line.

6. The fuel system of claim 1, wherein the first valve further comprises:
a control chamber between the housing of the first valve and the spool of the first valve, wherein the spool is between the control chamber and the inlet of the first valve; and
a spring in the control chamber.

7. The fuel system of claim 4, further comprising:
a third valve in the first line fluidically between the reference pressure source and the first damping port of the first valve, wherein the third valve comprises:
a third housing extending between a first end and a second end of the third valve, the third housing comprising:
a first port; and
a second port;
a third spool in the third housing, wherein the third spool comprises:
a first side opposite a second side; and
a window between the first side and the second side of the third spool, wherein the window of the third spool is fluidically connected to the first port and the second port;
a first control chamber between first side of the third spool and the first end of the third valve, wherein the first control chamber is fluidically connected to the inlet of the first valve to sense a pressure of the inlet of the first valve;
a second control chamber between a second side of the third spool and the second end of the third valve, wherein the second control chamber is fluidically connected to the outlet of the first valve to sense a pressure of the outlet of the first valve; and
a spring in the second control chamber.

8. The fuel system of claim 7, wherein the first line further comprises:
a first sub-line fluidically connecting the first port of the third valve to the reference pressure source; and
a second sub-line fluidically connecting the second port of the third valve to the first damping port of the first valve.

9. The fuel system of claim 4, further comprising:
a third valve in the third line, wherein the third valve comprises:
a third housing extending between a first end and a second end of the third valve, the third housing comprising:
a first port; and
a second port;
a third spool in the third housing, wherein the third spool comprises:
a first side opposite a second side; and
a window between the first side and the second side of the third spool, wherein the window of the third spool is fluidically connected to the first port and the second port;
a first control chamber between first side of the third spool and the first end of the third valve, wherein the first control chamber is fluidically connected to the inlet of the first valve to sense a pressure of the inlet of the first valve;
a second control chamber between a second side of the third spool and the second end of the third valve, wherein the second control chamber is fluidically connected to the outlet of the first valve to sense a pressure of the outlet of the first valve; and
a spring in the second control chamber.

10. The fuel system of claim 9, wherein the third line further comprises:
a first sub-line fluidically connecting the first port of the third valve to the first line; and
a second sub-line fluidically connecting the second port of the third valve to the second line.

11. The fuel system of claim 10, further comprising:
a first orifice in the third line and fluidically between third valve and the second line; and
a second orifice in the second line and fluidically between the second damping port of the first valve and a connection between the second line and the third line.

12. A fluid system comprising:
a reference pressure source;
a first valve comprising:
a housing comprising:
a first damping port fluidically connected to the reference pressure source; and
a second damping port fluidically connected to the reference pressure source;
a spool moveable within the housing, wherein the spool comprises:
a damping window formed on the spool, wherein the damping window fluidically connects the first damping port to the second damping port; and
a second valve fluidically connected to at least one of the first damping port and the second damping port.

13. The fluid system of claim 12, wherein the first valve further comprises:
an inlet; and
an outlet fluidically connected to the inlet, wherein the spool is moveable within the housing to fluidically open and close the inlet relative to the outlet.

14. The fluid system of claim 13, wherein the second valve comprises:
a housing comprising a first end and a second end; and
a spool within the housing and between the first and second end, wherein the spool of the second valve comprises:
a reference surface facing the first end of the housing of the second valve; and
a control surface facing a second end of the housing of the second valve.

15. The fluid system of claim 14, further comprising:
a first line fluidically connecting the first damping port to the reference pressure source; and
a second line fluidically connecting the second damping port to the reference side of the spool of the second valve.

16. The fluid system of claim 15, further comprising:
a third line fluidically connecting the first line to the second line.

17. The fluid system of claim 16, further comprising:
a third valve in the third line, wherein the third valve comprises:
a third housing extending between a first end and a second end of the third valve, the third housing comprising:
a first port fluidically connected to the reference pressure source and the first damping port; and
a second port fluidically connected to the damping window by the second damping port;
a third spool in the third housing, wherein the third spool comprises:
a first side opposite a second side; and
a window between the first side and the second side of the third spool, wherein the window of the third spool is fluidically connected to the first port and the second port;
a first control chamber between first side of the third spool and the first end of the third valve, wherein the first control chamber is fluidically connected to the inlet of the first valve to sense a pressure of the inlet of the first valve;
a second control chamber between a second side of the third spool and the second end of the third valve, wherein the second control chamber is fluidically connected to the outlet of the first valve to sense a pressure of the outlet of the first valve; and
a spring in the second control chamber.

18. The fuel system of claim 17, further comprising:
a first orifice in the third and fluidically between third valve and the second line; and
a second orifice in the second line and fluidically between the second damping port of the first valve and a connection between the second line and the third line.

19. The fluid system of claim 16, further comprising:
a third valve in the first line fluidically between the reference pressure source and the first damping port of the first valve, wherein the third valve comprises:
a third housing extending between a first end and a second end of the third valve, the third housing comprising:
a first port; and
a second port;
a third spool in the third housing, wherein the third spool comprises:
a first side opposite a second side; and
a window between the first side and the second side of the third spool, wherein the window of the third spool is fluidically connected to the first port and the second port;
a first control chamber between first side of the third spool and the first end of the third valve, wherein the first control chamber is fluidically connected to the inlet of the first valve to sense a pressure of the inlet of the first valve;
a second control chamber between a second side of the third spool and the second end of the third valve, wherein the second control chamber is fluidically connected to the outlet of the first valve to sense a pressure of the outlet of the first valve; and
a spring in the second control chamber.

20. The fuel system of claim 19, further comprising:
a first orifice in the third; and
a second orifice in the second line and fluidically between the second damping port of the first valve and a connection between the second line and the third line.
